(19) United States
(12) Patent Application Publication
(10) Pub. No.: US 2011/0138886 A1
(43) Pub. Date: Jun. 16, 2011

(54) Refrigerated Transport System Testing

(75) Inventors: Patrick McDonald, Athens, GA (US); David M. Embler, Athens, GA (US); Curtis E. Cole, Hull, GA (US); Alfred H. Chilton, Buford, GA (US)

(73) Assignee: CARRIER CORPORATION, Farmington, CT (US)

(21) Appl. No.: 12/995,575

(22) PCT Filed: Jul. 2, 2009
(86) PCT No.: PCT/US09/49542

§ 371 Date: Dec. 1, 2010

Related U.S. Application Data
(60) Provisional application No. 61/078,367, filed on Jul. 4, 2008.

(51) Int. Cl. G01M 3/18; F25B 1/00; F25D 17/02; F25D 17/06

(52) U.S. Cl. 73/46; 62/498; 62/180

(57) ABSTRACT

A method involves inspecting/testing a refrigeration system. One or more conduits or other components cooperate with the compressor, heat rejection heat exchanger, expansion device, and heat absorption heat exchanger to define a refrigerant flowpath. The inspecting/testing method comprises placing a plurality of collars over respective joints along the refrigerant flowpath. The collars each define a space that may be exposed to one or more sensors. Based upon input from the sensors, the presence or absence of leaks at the joints is determined.

### CROSS-REFERENCE TO RELATED APPLICATIONS

Benefit is claimed of U.S. Patent Application Ser. No. 61/078,367, filed Jul. 4, 2008, and entitled “REFRIGERATED TRANSPORT SYSTEM TESTING”, the disclosure of which is incorporated by reference herein in its entirety as if set forth at length.

### BACKGROUND

The disclosure relates to refrigeration. More particularly, the disclosure relates to refrigeration system testing.

An exemplary refrigeration system is a transport refrigeration system used to control enclosed areas, such as the box used on trucks, trailers, containers, or similar intermodal units, functions by absorbing heat from the enclosed area and releasing heat outside of the box into the environment. A number of transport refrigeration units employ a reciprocating compressor to pressurize refrigerant to enable the removal of heat from the box. Reciprocal compressors used in such applications commonly include a suction inlet and a discharge which are connected, respectively, to the evaporator and condenser of the transport refrigeration system. It is axiomatic that in order to ensure the reliability of the reciprocating compressor, the compressor should operate within the limits of the suction and discharge pressures for which it was designed. The ranges and ratios of suction and discharge pressures designed to be handled by a reciprocating compressor at various stages of operation is known as an operating envelope. The failure to operate within the compressor operating envelope will result in unnecessary wear and tear, and ultimately will bring about the premature failure of the compressor, thus creating unacceptable costs of money and time to the operator.

Exemplary refrigerated transport systems use generators powered by internal combustion engines to power the compressors and any fans associated with the evaporator and condenser. U.S. Pat. No. 6,321,550, the disclosure of which is incorporated by reference in its entirety herein as if set forth at length, assigned to the assignee of the present application, discloses such a generator and associated control methods.

There are many operational considerations for the units. Several considerations involve the temperature at which the enclosed area is to be kept. A given unit configuration may be made manufactured for multiple operators with different needs. Broadly, the temperature may be separated into two fields: frozen goods; and non-frozen perishables. An exemplary frozen goods temperature is about −10° F. or less an exemplary non-frozen perishable temperature is 34-38° F.

### SUMMARY

One aspect of the disclosure involves a method for inspecting/testing a refrigeration system. The system includes a compressor. A heat rejection heat exchanger is coupled to the compressor to receive compressed refrigerant from the compressor. Expansion device is coupled to the heat rejection heat exchanger to expand refrigerant received from the heat rejection heat exchanger. The heat absorption heat exchanger is coupled to the expansion device to receive refrigerant expanded by the expansion device and, in turn, coupled to the compressor to return refrigerant to the compressor. One or more conduits or other components (e.g., fittings, valves, sensors, and the like) cooperate with the compressor, heat rejection heat exchanger, expansion device, and heat absorption heat exchanger to define a refrigerant flowpath. The inspecting/testing method comprises placing a plurality of collars over respective joints along the refrigerant flowpath. The collars each define a space or chamber that may be exposed to one or more sensors. Based upon input from the sensors, the presence or absence of leaks at the joints is determined.

In various implementations, the collars may be split collars. The placing may comprise assembling two halves of each split collar over the associated joint and clamping (e.g., self-sprung clamping) the halves together. The collars may include a port which may permit communication with a separate such sensor. The separate sensor may, sequentially, be exposed to the port of the various collars. The sensors may be chemical sensors. The system may be charged with a test fluid comprising at least 50% nitrogen, by weight, and less than 10% hydrogen by weight. The leak may be determined by chemical detection of the hydrogen leaking from the joint. After a successful test, the refrigeration system may be assembled to a refrigerated compartment positioned to be cooled by the heat absorption heat exchanger.

The collar body may be spring biased/loaded toward a closed condition from an open condition. The body halves may be hinged and, opposite the hinge on the halves, the collar may include a pair of finger levers positioned to be compressed toward each other to open the body. The body may be resinous.

The refrigeration system may be that of a refrigerated transport system and may be tested on an assembly line. The refrigeration system may be tested separately from or together with the container (e.g., a truck, trailer, or cargo container). At testing, the system may include a generator for powering the compressor. At least one first selected fan may be positioned to drive an airflow across the heat rejection heat exchanger and at least one second fan positioned to drive an airflow across the heat absorption heat exchanger. The first and second fans may be coupled to the generator to receive electric power from the generator. A controller may be coupled to the compressor and fans to control their operation and operation of the generator.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a view of a refrigerated transport system.

FIG. 2 is a schematic view of a refrigeration system of the transport system of FIG. 1.

FIG. 3 is a first view of the refrigeration system of FIG. 2

FIG. 4 is a second view of the refrigeration system of FIG. 2.

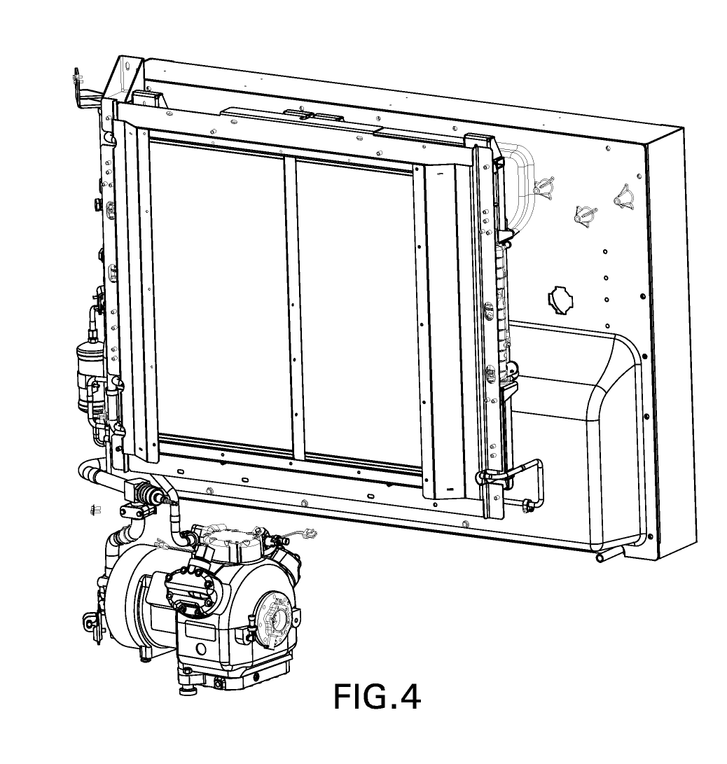

FIG. 5 is a third view of the refrigeration system of FIG. 2.

FIG. 6 is a view of a collar for inspecting/testing a joint in the refrigeration system of FIG. 2.

FIG. 7 is an open view of the collar of FIG. 6.

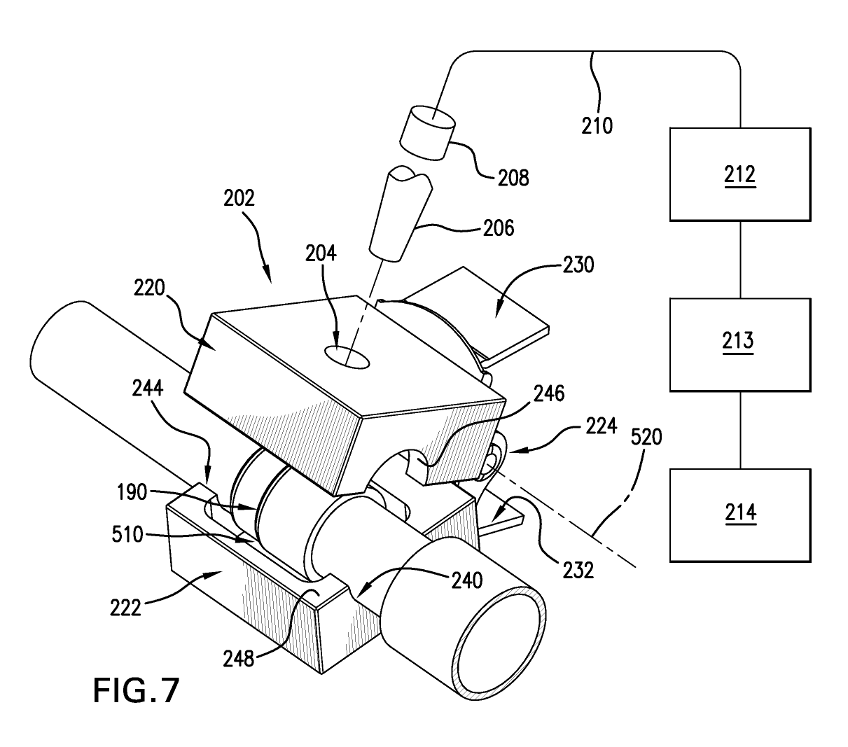

FIG. 8 is a partial cutaway view of the collar of FIG. 6 in a closed condition.

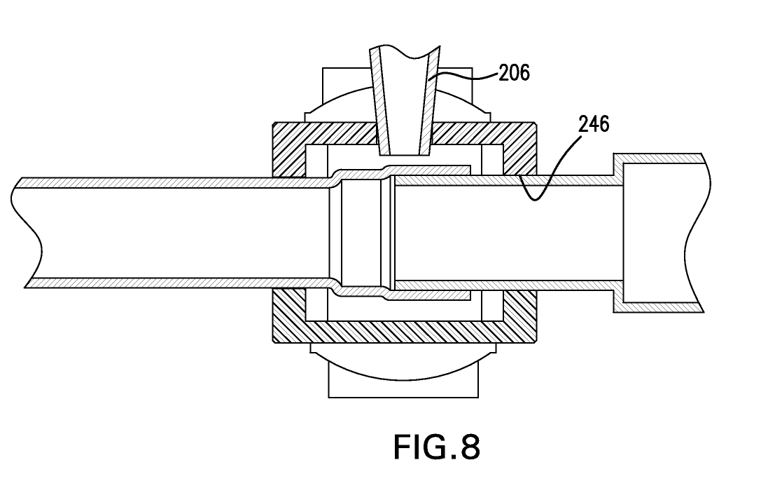

FIG. 9 is a rear isometric view of the collar of FIG. 6 in a closed condition.

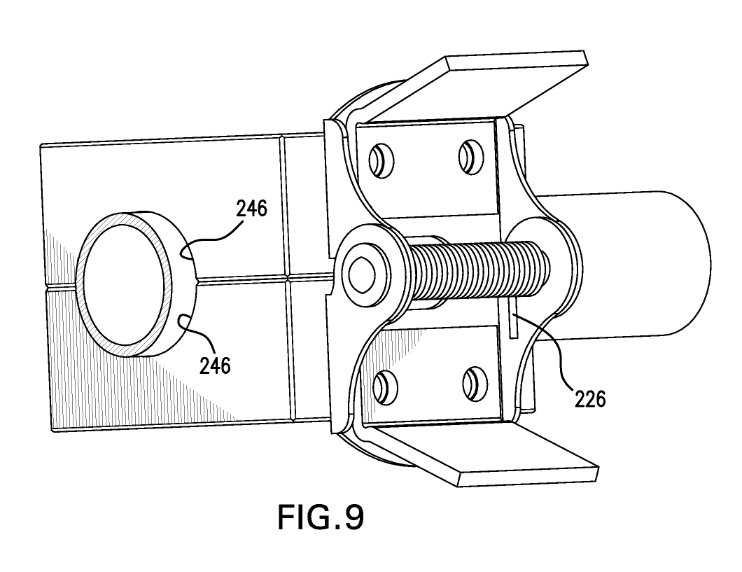

FIG. 10 is a top view of an alternate collar.

Like reference numbers and designations in the various drawings indicate like elements.

### DETAILED DESCRIPTION

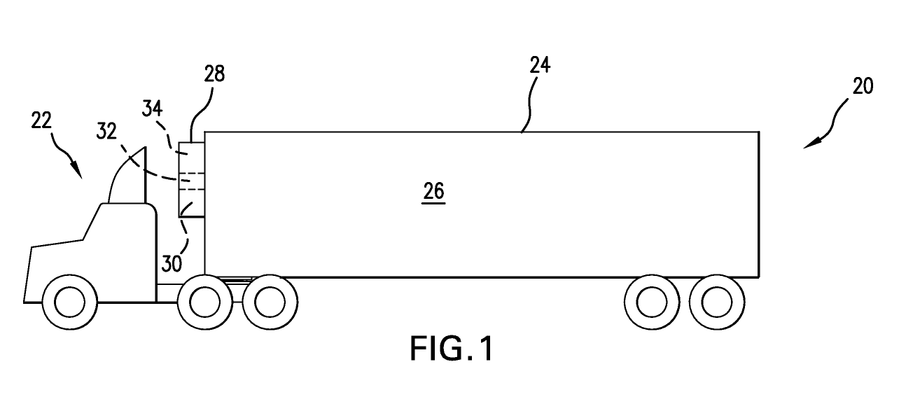

FIG. 1 shows a refrigerated transport unit (system) 20 in the form of a refrigerated trailer. The trailer may be pulled by a tractor 22. The exemplary trailer includes a container/box 24 defining an interior/compartment 26. The container/box 24 may be a removable cargo container. An equipment housing 28 mounted to a front of the box 24 may contain an electric generator system including an engine 30 (e.g., diesel) and an electric generator 32 mechanically coupled to the engine to be driven thereby. A refrigeration system 34 may be electrically coupled to the generator 32 to receive electrical power.

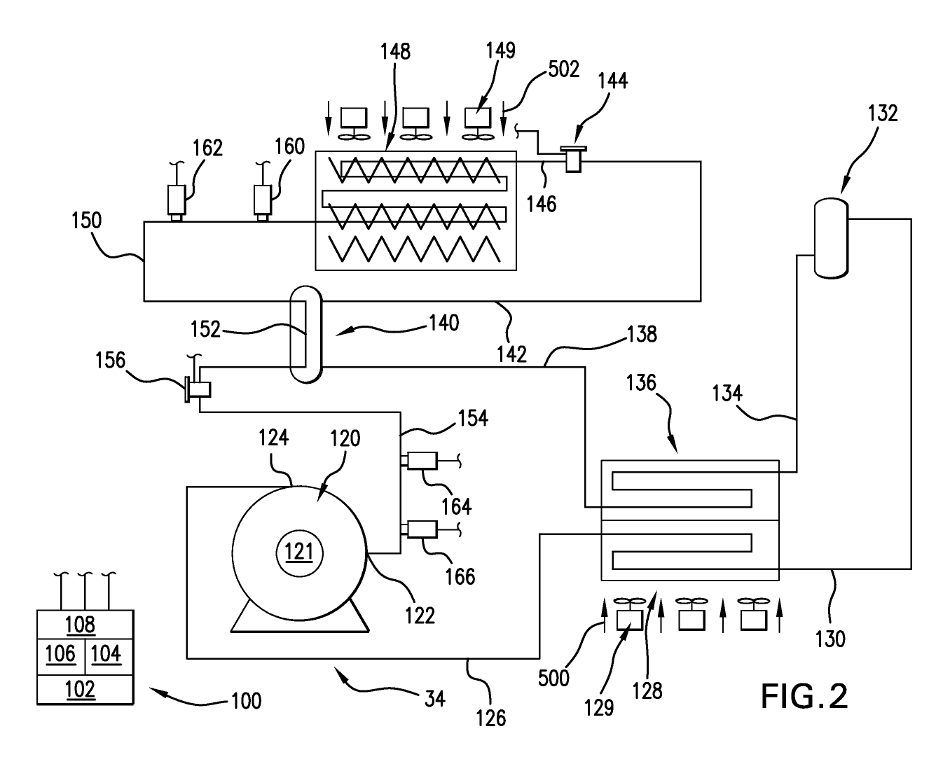

FIG. 2 shows further details of the exemplary refrigeration system 34. The system 34 includes a control system 100. The control system 100 may include: one or more user interface (e.g., input/output) devices 102; processors 104; memory 106; and hardware interface devices 108 (e.g., ports). An exemplary system 34 is illustrated based upon the system of PCT/US07/60220. Further details of such a system are shown in U.S. Pat. No. 6,321,550.

The system 34 further includes a compressor 120 having a suction (inlet) port 122 and a discharge (outlet) port 124. An exemplary compressor 120 is an electrically-powered reciprocating compressor having an integral electric motor. The compressor 120 may be coupled to the control system (controller) 100 to regulate its operation and to the generator 32 to receive power. A discharge line section/segment 126 extends from the discharge port 124 downstream along a refrigerant primary flowpath to an inlet of a heat rejection heat exchanger (condenser) 128. A hot liquid refrigerant line section/segment 130 extends downstream from an outlet of the condenser 128 to an inlet of an exemplary receiver 132. A hot liquid line section/segment 134 extends from an outlet of the receiver 132 to an inlet of a subcooler 136. The subcooler 136 and condenser 128 may be positioned to receive an external airflow (e.g., driven by one or more fans 129). A liquid line section/segment segment 138 extends downstream from an outlet of the subcooler 136 to an inlet of a suction line heat exchanger (SLHX) 140. A further liquid line section/segment 142 of the refrigerant line extends downstream from an outlet of the SLHX 140 to an inlet of an expansion device (e.g., an electronic expansion valve (EEV)) 144. A final liquid line section/segment 146 extends from an outlet of the electronic expansion valve 144 to an inlet of a heat absorption heat exchanger (evaporator) 148. The evaporator 128 may be positioned to receive an external airflow (e.g., driven by one or more fans 149). A first section/segment 150 of a suction line extends downstream from the outlet of the evaporator 148 to the suction line heat exchanger 140. A second section/segment 152 of the suction line extends within the suction line heat exchanger 140 to form a downstream leg in heat exchange relation with fluid in the upstream leg of the heat exchanger 140. A final section/segment 154 of the suction line returns to the suction port 122. A compressor suction modulation valve (CSMV) 156 may be located in the line 154

The physical configuration of the system is merely illustrative and may schematically represent any of a number of existing or yet-developed constructions. The inventive methods described below may also be applicable to other constructions.

The system 34 may include various additional components including valves, sensors, and the like. Of these, sufficient sensors for determining a characteristic evaporator superheat and a characteristic suction superheat are required and particular exemplary implementations are described below. An exemplary characteristic evaporator superheat is an evaporator outlet superheat (EVOSH) and may be determined responsive to measurements of an evaporator outlet temperature (EVOT) and an evaporator outlet pressure (EVOP). Accordingly, the exemplary system 34 includes an EVOP sensor 160 and an EVOT sensor 162 along the segment 150 and in signal communication with the control system 100. The suction superheat (SSH) may similarly be determined responsive to measurements of compressor suction temperature (CST) and compressor suction pressure (CSP). Along the segment 154 downstream of the SLHX 140, a pressure sensor 164 and a temperature sensor 166 are similarly positioned for measuring CSP and CST, respectively.

In operation, a user will enter a temperature at which the compartment 26 is to be maintained. In one basic example, immediate entry may be by means of a simple two position switch wherein one position is associated with frozen goods and another position is associated with non-frozen perishable goods. The control system 100 may be pre-programmed (via software or hardware) with associated target compartment temperatures. For example, a frozen goods target temperature may typically be a particular temperature in a range of about −10° F. or below whereas a non-frozen perishable goods temperature may be a particular temperature in a range of about 34-38° F. The particular values may be pre-set according to the needs of the particular unit operator.

Prior to use, it is desirable to inspect the joints to verify their integrity (i.e., that the joints are not leaking). Testing may occur in one or more of several stages, depending upon the manufacturing process. An exemplary manufacturing process involves pre-assembly of portions of the refrigeration system in discrete modules. This may be done away from a final assembly assembly line (e.g., offsite at different vendors). Assembly on the final assembly assembly line may thus involve forming a relatively small number of the total number of joints. These joints may comprise one or more fittings securing conduit segments to each other or may comprise additional components. Exemplary joining involves brazing of the fitting(s) to the conduit segments and, if appropriate, to each other. There may be braze defects allowing leaks. Efficient inspection of these particular joints 190 (the “final assembly joints”) may contribute to the efficiency of the final assembly assembly line. The other joints (within the respective modules) may have been already tested.

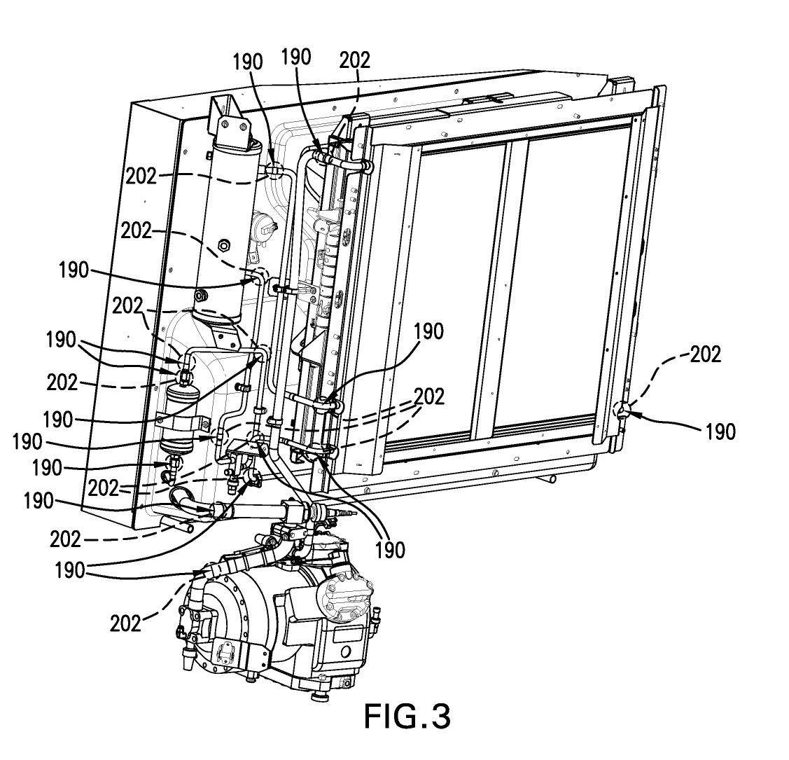

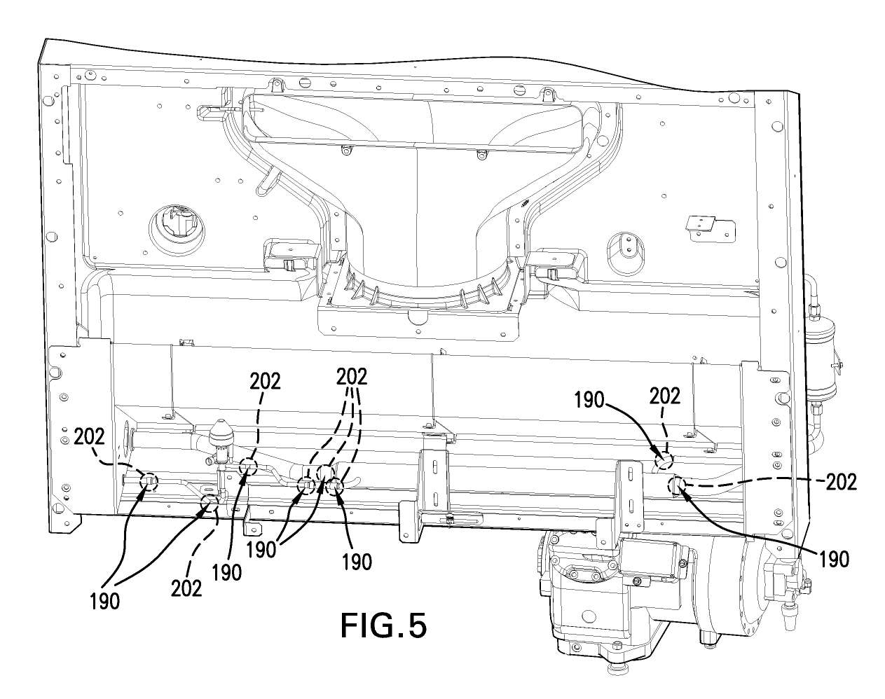

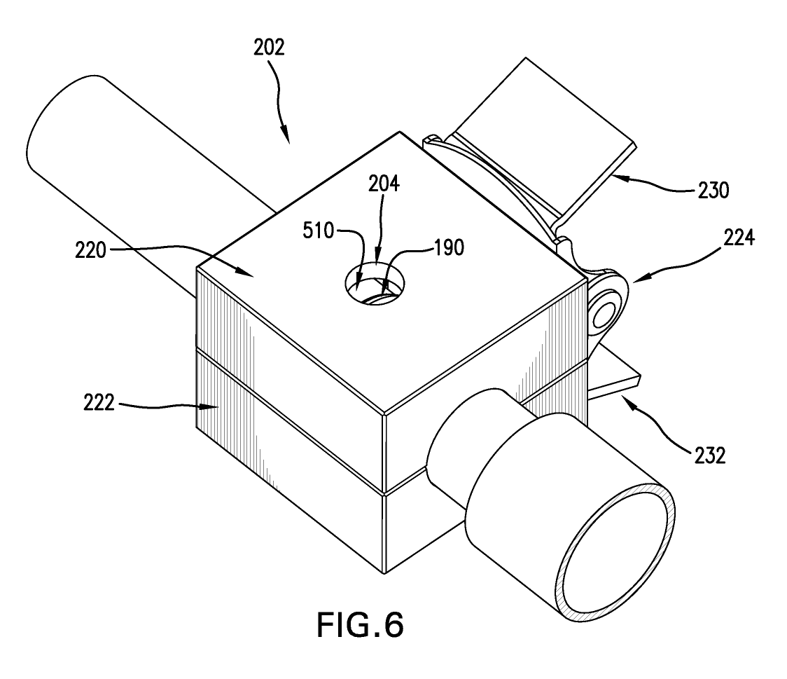

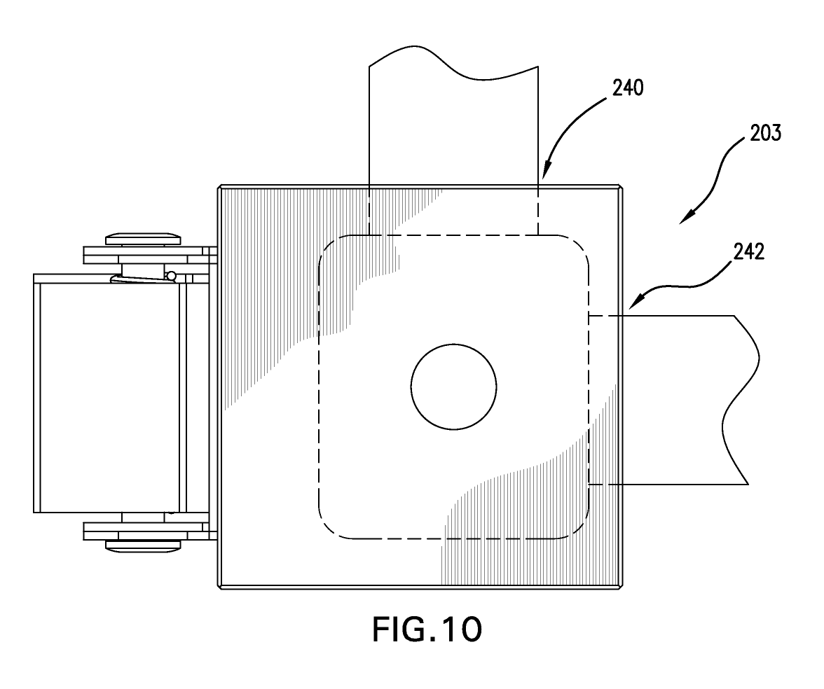

In an exemplary inspection/testing process, the modules are assembled to each other. A test system 200 includes a plurality of collars 202 (FIGS. 6&7) and 203 (FIG. 10) which may be placed over respective ones of the final assembly joints 190. FIGS. 3 and 5 schematically label these (with broken lines so as to not obscure the joints) and all with numeral 202 (although the specific collar configurations would vary). The joints 190 may take different forms (e.g., different sizes, and different configurations such as in-line, right angle, tee, and the like). The collars may be provided in a variety of configurations and sizes corresponding to the joints. As is discussed below, the exemplary collars 202 are shown for in-line joints while the collar 203 is otherwise similar but configured for a right angle joint. The system may be charged with refrigerant or with a test fluid. The exemplary collars 202 each include a port 204 for coupling to a sensor probe 206 for detecting leakage from the joint. With an exemplary test fluid as a gaseous mixture comprising, by majority weight, a relatively inert component (e.g., nitrogen) and a smaller amount of a relatively reactive component (e.g., hydrogen), exemplary sensors 208 are chemical sensors for detecting the reactive component. With a more inert fluid (e.g., pure helium), alternative sensors include pressure transducers. For detecting hydrogen, the exemplary sensor uses a transistor (e.g., MOSFET). Such detectors are available under the Adixen-Sensistor brand from Adixen Sensistor AB, Box 76, SE-58102 Linköping, Sweden or Alcatel Vacuum Products, Hingham, Mass.

The exemplary probe 206 and its sensor 208 are connected by wiring 210 to a monitoring system 212. The exemplary monitoring system is a personal computer. The personal computer may be connected to a gateway controller 213 which also controls a programmable logic controller 214 controlling the assembly line and other stations therealong. The system 212 may include a monitor or display and various input devices (e.g., keyboard, integrated touch screen, and the like).

The exemplary collars 202 are split collars wherein a body has a first piece 220 and a second piece 222, permitting the pieces 220 and 222 to be assembled over the joint and secured to each other (e.g., via one or more clamps formed separately from the body or integral to the body). The body and conduit define a space/chamber 510 surrounding the associated joint when the body is assembled over the joint. An exemplary body material is an acetal resin (e.g., Delrin acetal resin from E.I. du Pont de Nemours and Company, Wilmington, Del.). The body halves may be machined from stock pieces of the resin. The resin may have lower chances of outgassing trapped hydrogen than does a typical aluminum alloy. The resin may also offer good self sealing characteristics to avoid the need for separate seals. Alternatively, the body may carry seals for sealing the space/chamber 510. Exemplary clamping is a hinged clamping wherein the body pieces or halves 220 and 222 are coupled by a hinge 224. The exemplary hinge 224 is spring-loaded by a spring 226 (e.g., torsion coil or metal or plastic/resin flex leaf) biasing the two halves towards a closed orientation about a hinge axis 520. The exemplary collar includes a pair of finger levers 230 and 232 (e.g. which may be unitarily formed with halves of the hinge body or otherwise respectively secured to the two body pieces such as by screws—not shown). Exemplary levers 230 and 232 may be squeezed toward each other to open the body against spring bias. In the exemplary split body, ports 240 and 244 for accommodating and sealing with the portions of the refrigerant are on opposite sides of the joint and are each formed by a pair of semi-cylindrical surfaces 246 in the respective body halves. The exemplary body halves are square or, more broadly, approximately rectangular in planform and have flat perimeter rim surfaces 248 which mate/seal with each other in the closed condition and laterally surround the chamber.

In the FIG. 10 embodiment, the ports 240 and 242 are at right angles to each other for accommodating a right angle joint.

In use, at the testing station along the final assembly line, the test technician may place a plurality of the collars 202 over the associated joints. The technician may also connect the source of the test fluid. Exemplary test fluid is at least 50% nitrogen (N₂) by weight and less than 10% hydrogen (e.g., 2-8% hydrogen, remainder nitrogen, with a particular example of 5-5.7% hydrogen, remainder nitrogen). The monitoring system may command an initial low pressure decay test (e.g., at 25 psi) where a sensed pressure decay will indicate a relatively large leak. This low pressure test may be performed before or after collar installation. If before, and the system passes the test, the collar may then be installed. In various implementations, there may also be a high pressure test after successful passing of the low pressure test (e.g., and before sniff testing). The monitoring system then commands a low pressure leak detection sniff test (e.g., at 100 psi). The monitoring system may instruct the technician to sequentially apply the probe to each specific collar and, when applied, check the sensor for evidence of leakage and may record results. After the test, the monitoring system may instruct disconnection of any fluid source and may display final results (e.g., binary leak/no leak or pass/fail or leak rates associated with each joint). Such results may similarly be displayed in real time during testing.

If one or more of the joints is found to be leaking, the monitoring system may cause a halt in the progress of the leaking unit down the assembly line. The associated collar may be removed from that joint, the fluid may be fully or locally evacuated from the system, and the joint repaired/replaced. The collar (or a similar collar) may be replaced and the system may be retested. After testing, the collars may be removed and installed on a subsequent refrigeration system along the production line. Upon successful testing, the test fluid (if used) may be evacuated from the system and the system charged with refrigerant.

One or more embodiments have been described. Nevertheless, it will be understood that various modifications may be made. For example, the test methods and collars may be adapted to a variety of existing or yet-developed systems. Additionally, consideration of the test methods and collars may be made in designing or redesigning a system (e.g., to provide easier access to the joints). Accordingly, other embodiments are within the scope of the following claims.

What is claimed is:

1. A refrigeration system comprising:
a compressor (120);
a heat rejection heat exchanger (128) coupled to the compressor to receive compressed refrigerant from the compressor;
an expansion device (144) coupled to the heat rejection heat exchanger to expand refrigerant received from the heat rejection heat exchanger;
a heat absorption heat exchanger (128) coupled to the expansion device to receive refrigerant expanded by the expansion device and, in turn, coupled to the compressor to return refrigerant to the compressor;
one or more conduits (126, 134, 138, 142, 146, 150, 152, 154) or other components cooperating with the compressor, heat rejection heat exchanger, expansion device, and heat absorption heat exchanger to define a refrigerant flowpath; and
a plurality of collars (202; 203) over respective joints (190) along the refrigerant flowpath, the collars each defining a chamber (510) around the associated joint.

2. The system of claim 1 wherein:
the collars each have a port (204).

3. The system of claim 1 wherein:
the collars each have a split body (220, 222).

4. The system of claim 3 wherein:
two halves (220, 222) of the split body are spring-biased (226) into a closed condition.

5. The refrigeration system of claim 4 wherein:
the two halves are hinged and, opposite the hinge on the halves the collar includes a pair of finger levers (230; 232) positioned to be compressed toward each other to open the body.

6. The system of claim 3 wherein:
the split body is resinous.

7. The system of claim 1 further comprising:
an engine (30);
an electric generator (32) mechanically coupled to the engine to be driven by the engine, the compressor (120) electrically coupled to the generator to be powered by the generator;
at least one first electric fan (129) positioned to drive an airflow across the heat rejection heat exchanger and coupled to the generator to receive electric power from the generator;
at least one second electric fan (149) positioned to drive an airfoil across the heat absorption heat exchanger and coupled to the generator to receive electric power from the generator; and
a controller (100) coupled to the compressor and fans.

8. The system of claim 1 wherein:
at least one said joint is a braze joint.

9. A method for inspecting a refrigeration system, the system comprising:
a compressor (120);
a heat rejection heat exchanger (128) coupled to the compressor to receive compressed refrigerant from the compressor;
an expansion device (144) coupled to the heat rejection heat exchanger to expand refrigerant received from the heat rejection heat exchanger;
a heat absorption heat exchanger (128) coupled to the expansion device to receive refrigerant expanded by the expansion device and, in turn, coupled to the compressor to return refrigerant to the compressor; and
one or more conduits (126, 134, 138, 142, 146, 150, 152, 154) or other components cooperating with the compressor, heat rejection heat exchanger, expansion device, and heat absorption heat exchanger to define a refrigerant flowpath;
the method comprising:
placing a plurality of collars (202; 203) over respective joints (190) along the refrigerant flowpath, the collars each defining a space; exposing one or more sensors to the space; and
based upon input from the sensors, determining the presence or absence of leaks at the joints.

10. The method of claim 9 wherein:
the collars are split collars and the placing comprises assembling two halves of each split collar over the associated joint and clamping the halves together.

11. The method of claim 10 wherein:
the closing comprises a self-sprung spring clamping.

12. The method of claim 9 wherein:
the sensors are chemical sensors.

13. The method of claim 9 further comprising:
charging the system with a fluid comprising at least 50% N₂, by weight, and less than 10% H by weight.

14. The method of claim 13 wherein:
at least one said leak is determined by chemical detection of the hydrogen leaking from a said joint.

15. The method of claim 9 wherein:
the collars each have a port (204); and
the exposing comprises sequentially placing a probe (206) having said one or more sensors (208) in communication with the port of the respective collars.

16. The method of claim 9 further comprising assembling the refrigeration system to a refrigerated compartment (26) positioned to be cooled by the heat absorption heat exchanger.

17. A refrigerant system testing collar for testing a joint along a line in a refrigeration system, the collar comprising:
a port (204) for coupling to a sensor probe; and
a pair of ports (240;244) for accommodating the refrigerant line.
